(19) United States
(12) Patent Application Publication
(10) Pub. No.: US 2024/0322294 A1
(43) Pub. Date: Sep. 26, 2024

(54) BATTERY PACK

(71) Applicant: Samsung SDI Co., Ltd., Yongin-si (KR)

(72) Inventors: Woojoon Chung, Yongin-si (KR); SeokChae Chang, Yongin-si (KR)

(21) Appl. No.: 18/617,320

(22) Filed: Mar. 26, 2024

(30) Foreign Application Priority Data
Mar. 26, 2023 (KR) 10-2023-0039400
Jan. 26, 2024 (KR) 10-2024-0012440

(51) Int. Cl. H01M 10/6555; H01M 10/613; H01M 10/647; H01M 10/658; H01M 50/209

(52) U.S. Cl. CPC H01M 10/6555; H01M 10/613; H01M 10/647; H01M 10/658; H01M 50/209

(57) ABSTRACT

A battery pack includes battery cells arranged in a row in a first direction and a cooling plate and a heat insulation sheet located between each pair of adjacent battery cells in the row. An arrangement between the cooling plate and the heating insulation sheet is a same between each of the pair of adjacent battery cells in the row such that heat propagation is effectively blocked between adjacent battery cells, and a chain of thermal runaway due to the heat propagation is prevented.

### CROSS-REFERENCE TO RELATED APPLICATION

The present application claims priority to and the benefit of Korean Patent Application Nos. 10-2023-0039400, filed on Mar. 26, 2023, and 10-2024-0012440, filed on Jan. 26, 2024, in the Korean Intellectual Property Office, the entire disclosures of which are incorporated herein by reference.

### BACKGROUND

### 1. Field

One or more embodiments relate to a battery pack.

### 2. Description of the Related Art

In general, secondary batteries refer to batteries that may be recharged and discharged, unlike primary batteries that may not be recharged. Secondary batteries may be used as energy sources for mobile devices, electric vehicles, hybrid vehicles, electric bicycles, and uninterruptible power supplies and may be used in the form of a single battery or module in which a plurality of batteries are connected and grouped into one unit, according to types of external apparatuses applied.

Small mobile devices, such as mobile phones, may operate for a certain time with the output and capacity of a single battery, but if long-term driving and high-power driving are needed as in power-consuming electric vehicles and hybrid vehicles, module forms including a large number of batteries may be implemented due to power and capacity issues, and output voltages or output currents may increase according to the number of internal batteries.

### SUMMARY

One or more embodiments include a battery pack capable of effectively blocking heat propagation between adjacent battery cells and preventing a chain of thermal runaway due to the heat propagation.

Additional aspects will be set forth in part in the description which follows and, in part, will be apparent from the description, or may be learned by practice of the presented embodiments of the present disclosure.

According to one or more embodiments, a battery pack includes
a plurality of battery cells arranged in a row in a first direction and
a cooling plate and a heat insulation sheet located between battery cells adjacent to each other in the first direction and located between adjacent battery cells to maintain a same precedence relationship in the first direction.

Adjacent battery cells arranged in a row in the first direction may be arranged so that main surfaces occupying greatest areas from among each of the battery cells face each other.

The cooling plate and the heat insulation sheet may be
arranged, on the basis of one battery cell from among the plurality of battery cells,
to maintain a same precedence relationship in a precedence relationship of the cooling plate and the heat insulation sheet or a precedence relationship of the heat insulation sheet and the cooling plate in the first direction between the one battery cell and an adjacent front battery cell and in a precedence relationship of the cooling plate and the heat insulation sheet or a precedence relationship of the heat insulation sheet and the cooling plate in the first direction
between the one battery cell and an adjacent rear battery cell.

A relative arrangement between the cooling plate and the heat insulation sheet between the one battery cell and an adjacent front battery cell, and a relative arrangement between the cooling plate and the heat insulation sheet between the one battery cell and an adjacent rear battery cell may be asymmetrical with respect to each other on the basis of the one battery cell.

The cooling plate and the heat insulation sheet may be arranged so that
a distance relationship between the one battery cell and an adjacent front battery cell and a distance relationship between the one battery cell and an adjacent rear battery cell are reversed each other according to distance relationships arranged at relatively short distance location and long distance location from the one battery cell.

The plurality of battery cells may be two-dimensionally arranged in a plurality of rows and a plurality of columns by including
battery cells in a plurality of rows arranged in the first direction and
battery cells in a plurality of columns arranged in a second direction which intersects the first direction.

Battery cells adjacent to each other to form a same row in the first direction may be arranged so that main surfaces occupying greatest areas from among each of the battery cells face each other, and
battery cells adjacent to each other to form a same column in the second direction may be arranged so that first and second side surfaces occupying smallest areas from among each of the battery cells face each other.

The cooling plate and the heat insulation sheet may be
formed to be disconnected from each other with respect to each of a plurality of battery cells arranged to form a same row in the first direction and
integrally extend over a plurality of battery cells arranged to form a same column in the second direction.

A plurality of battery cells arranged to form a same column in the second direction may form an even heat distribution through the cooling plate.

Each of the plurality of battery cells may include a pair of main surfaces facing each other while occupying greatest areas and a pair of first and second side surfaces connecting the pair of main surfaces and facing each other while occupying smallest areas,
main surfaces of battery cells arranged adjacent to each other to form a same column in the second direction may be thermally connected to each other through the cooling plate, and
first and second side surfaces of battery cells arranged adjacent to each other to form a same column in the second direction may be thermally connected to each other while facing each other.

The cooling plate and the heat insulation sheet may be formed to be disconnected from each other with respect to each of a plurality of battery cells arranged to form a same row in the first direction,
the cooling plate may integrally extend over a plurality of battery cells arranged to form a same column in the second direction, and the heat insulation sheets may be individually formed to be disconnected
from each other with respect to each of the plurality of battery cells arranged to form a same column in the second direction.

The heat insulation sheets may be alternately arranged on a front surface and a rear surface of the cooling plate in the first direction along a plurality of battery cells arranged in the second direction to form a same column.

Each of the plurality of battery cells may include a pair of main surfaces facing each other while occupying greatest areas and a pair of first and second side surfaces connecting the pair of main surfaces and facing each other while occupying smallest areas,
first and second side surfaces of battery cells arranged adjacent to each other to form a same column in the second direction are thermally connected to each other while facing each other, and
main surfaces of battery cells arranged adjacent to each other to form a same column in the second direction may be insulated from each other from heat insulation sheets alternately arranged on a front surface and a rear surface of the cooling plate.

The cooling plate and the heat insulation sheet may be
formed to be disconnected from each other with respect to each of a plurality of battery cells arranged to form a same row in the first direction,
the heat insulation sheet may integrally extend over a plurality of battery cells arranged to form a same column in the second direction, and

The cooling plates may be individually formed to be disconnected from each other with respect to each of a plurality of battery cells arranged to form a same column in the second direction.
each of the plurality of battery cells may include a pair of main surfaces facing each other while occupying greatest areas and a pair of first and second side surfaces connecting the pair of main surfaces and facing each other while occupying smallest areas,
first and second side surfaces of battery cells arranged adjacent to each other to form a same column in the second direction may be thermally connected to each other while facing each other,
a heat flow between main surfaces of battery cells arranged adjacent to each other to form a same column in the second direction is disconnected from the cooling plates that are disconnected from each other with respect to each of a plurality of battery cells arranged to form a same column, and
battery cells in adjacent columns forming a column in the second direction may be insulated from each other from a heat insulation sheet integrally extending across between battery cells in adjacent columns.

The cooling plates and the heat insulation sheets may be
formed to be disconnected from each other with respect to each of a plurality of battery cells arranged adjacent to each other to form a same row in the first direction and
may be individually formed to be disconnected from each other with respect to each of a plurality of battery cells arranged adjacent to each other to form a column in the second direction.

The heat insulation sheets may be alternately arranged on a front surface and a rear surface of the cooling plate in the first direction along a plurality of battery cells arranged in the second direction to form a same column.

Each of the plurality of battery cells may include a pair of main surfaces facing each other while occupying greatest areas and a pair of first and second side surfaces connecting the pair of main surfaces and facing each other while occupying smallest areas,
first and second side surfaces of battery cells arranged adjacent to each other to form a same column in the second direction may be thermally connected to each other with facing each other, and
while a heat flow between main surfaces of a plurality of battery cells arranged to form a same column in the second direction is disconnected from cooling plates that are disconnected from each other with respect to respective battery cells arranged adjacent to each other to form a same column and the main surfaces are insulated from each other from heat insulation sheets alternately arranged on a front surface and a rear surface of the cooling plate.

A plurality of battery cells, which are two-dimensionally arranged in the first and second directions, may be arranged all together on a base frame forming a common support base for a plurality of battery cells.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a perspective view of a battery pack according to embodiments of the present disclosure;

FIG. 2 illustrates an exploded perspective view of the battery pack illustrated in the embodiment of FIG. 1;

FIG. 3 illustrates a perspective view of a battery cell illustrated in the embodiment of FIG. 1;

FIG. 4 is a view illustrating a portion of the battery pack illustrated in the embodiment of FIG. 1 and is a view illustrating, on the basis of any one battery cell, a heat flow between the one battery cell and an adjacent front battery cell and between the one battery cell and an adjacent rear battery cell;

FIG. 5A is a view illustrating an arrangement of battery cells, cooling plates, and heat insulation sheets in the battery pack in the embodiment illustrated in FIG. 1;

FIG. 5B is a view illustrating a portion of FIG. 5A and is a view illustrating a heat flow between adjacent battery cells;

FIG. 6A is a view illustrating an arrangement of battery cells, cooling plates, and heat insulation sheets in a battery pack according to embodiments of the present disclosure;

FIG. 6B is a view illustrating a portion of FIG. 6A and is a view illustrating a heat flow between adjacent battery cells;

FIG. 7A is a view illustrating an arrangement of battery cells, cooling plates, and heat insulation sheets in a battery pack according to embodiments of the present disclosure;

FIG. 7B is a view illustrating a portion of FIG. 7A and is a view illustrating a heat flow between adjacent battery cells;

FIG. 8A is a view illustrating an arrangement of battery cells, cooling plates, and heat insulation sheets in a battery pack according to embodiments of the present disclosure;

FIG. 8B is a view illustrating a portion of FIG. 8A and is a view illustrating a heat flow between adjacent battery cells;

FIG. 9A is a view illustrating an arrangement of battery cells, cooling plates, and heat insulation sheets in a battery pack according to embodiments of the present disclosure;

FIG. 9B is a view illustrating a portion of FIG. 9A and is a view illustrating a heat flow between adjacent battery cells; and

FIG. 10 is a view illustrating an arrangement of a battery cell, a cooling plate, and a heat insulation sheet in a battery pack according to embodiments of the present disclosure.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” if preceding a list of elements, modify the entire list of elements and do not modify the individual elements of the list.

Hereinafter, a battery pack according to embodiments will be described with reference to the accompanying drawings.

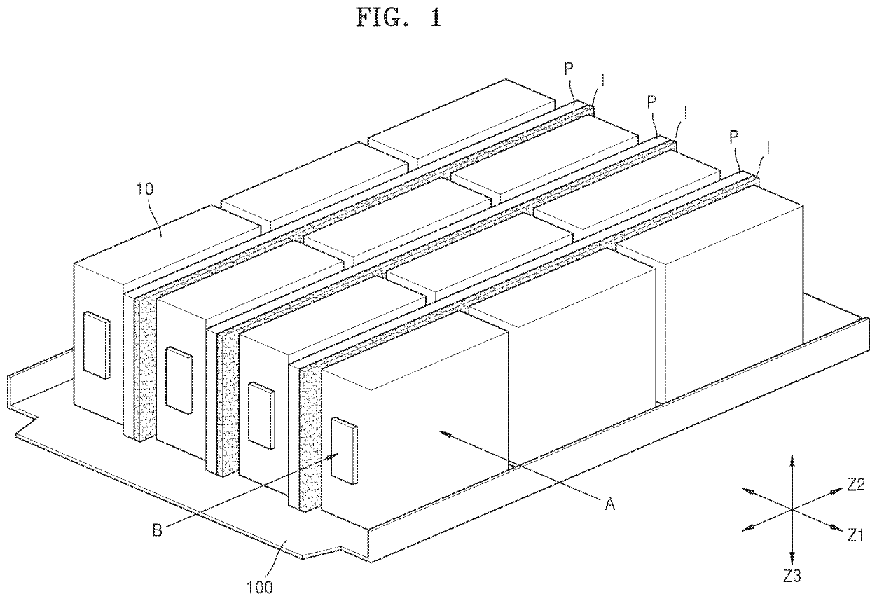

FIG. 1 illustrates a perspective view of a battery pack according to embodiments of the present disclosure.

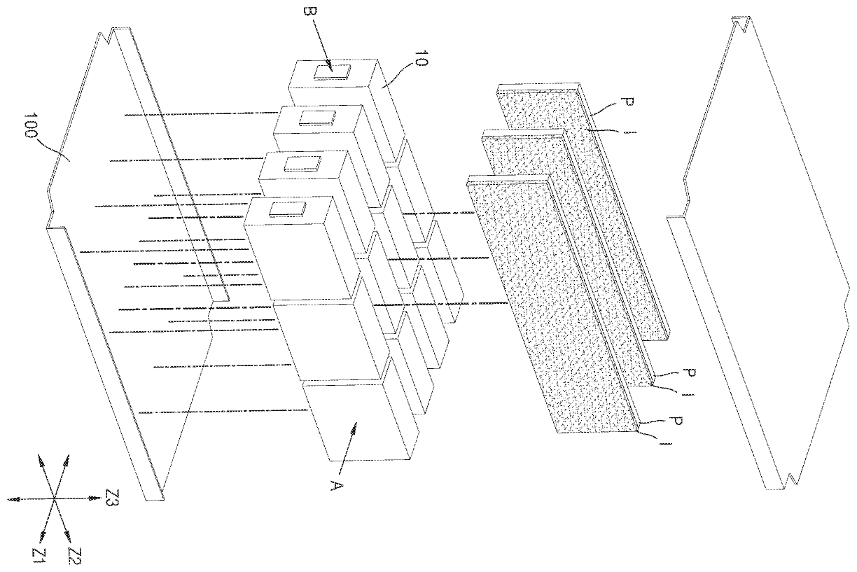

FIG. 2 illustrates an exploded perspective view of the battery pack illustrated in the embodiment of FIG. 1.

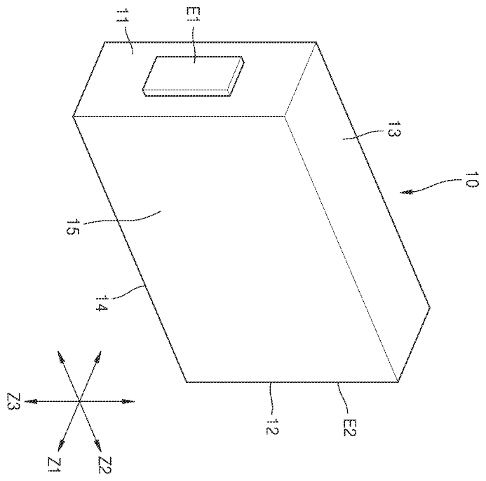

FIG. 3 illustrates a perspective view of a battery cell 10 illustrated in the embodiment of FIG. 1.

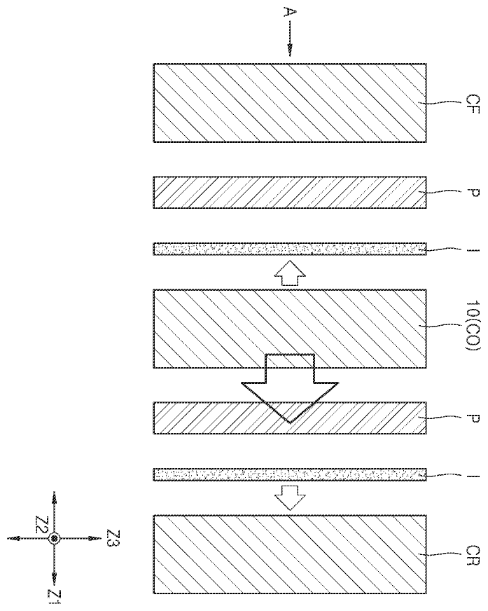

FIG. 4 is a view illustrating a portion of the battery pack illustrated in the embodiment of FIG. 1 and is a view illustrating, on the basis of any one battery cell 10, CO, a heat flow between the one battery cell 10, CO and an adjacent front battery cell CF and between the one battery cell 10, CO and an adjacent rear battery cell CR.

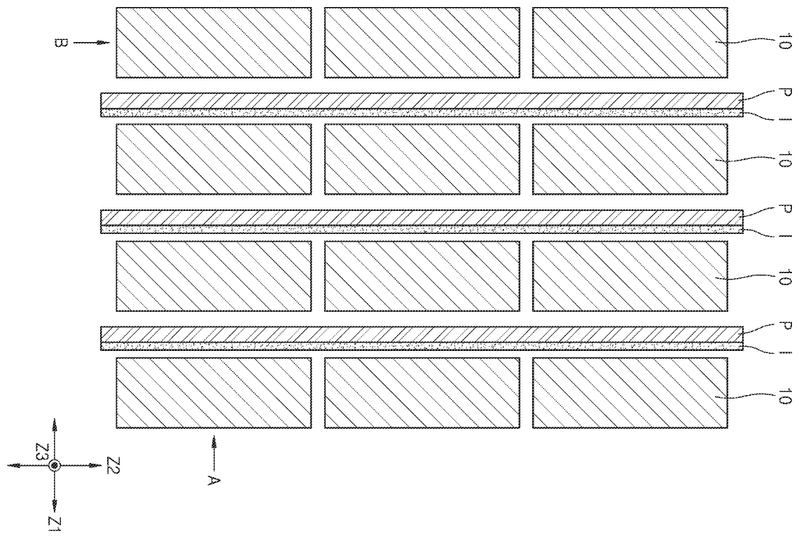

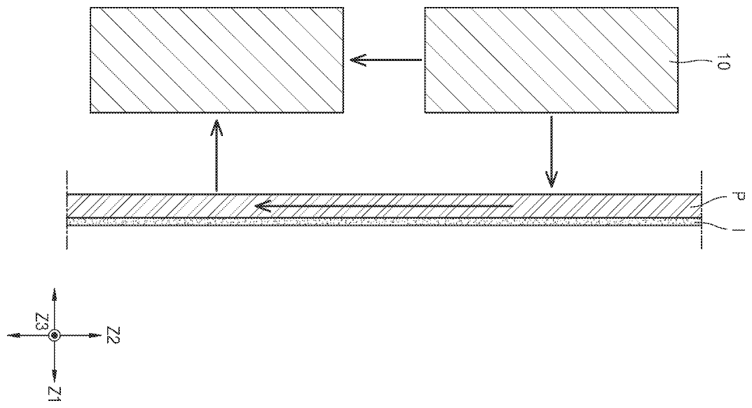

FIG. 5A is a view illustrating an arrangement of battery cells 10, cooling plates P, and heat insulation sheets I in the battery pack illustrated in the embodiment of FIG. 1.

FIG. 5B is a view illustrating a portion of FIG. 5A and is a view illustrating a heat flow between adjacent battery cells.

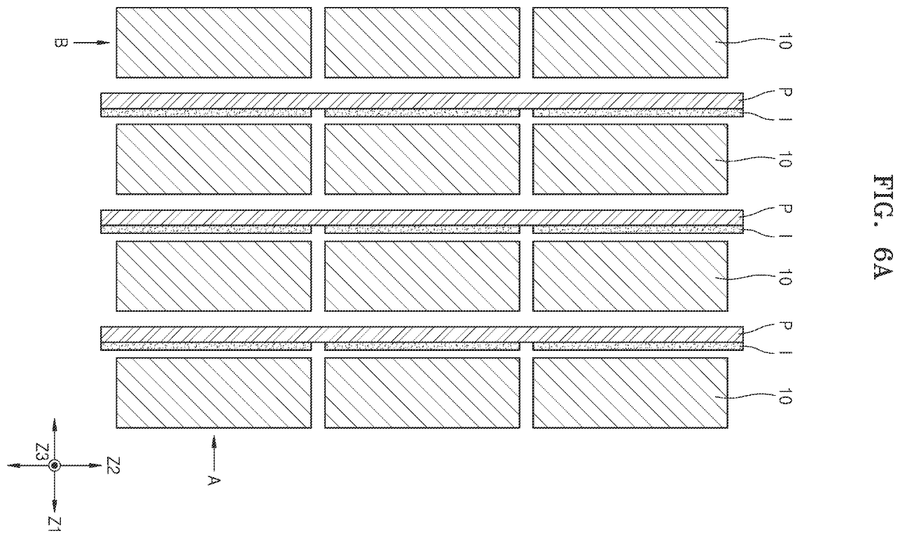

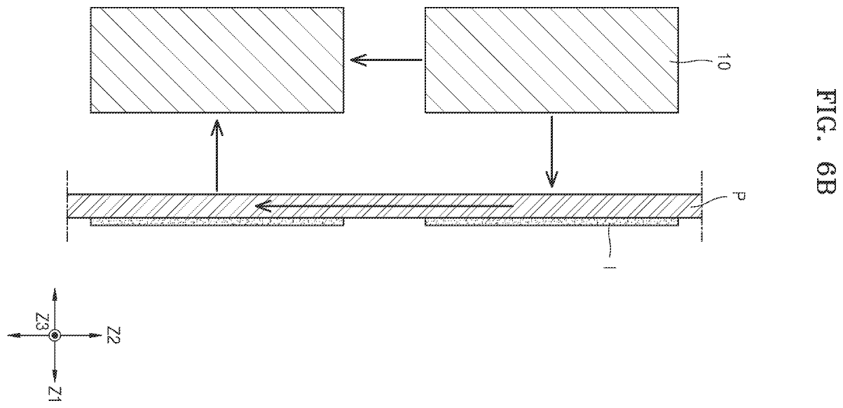

FIG. 6A is a view illustrating an arrangement of battery cells 10, cooling plates P, and heat insulation sheets I in a battery pack according to embodiments of the present disclosure.

FIG. 6B is a view illustrating a portion of FIG. 6A and a view illustrating a heat flow between adjacent battery cells.

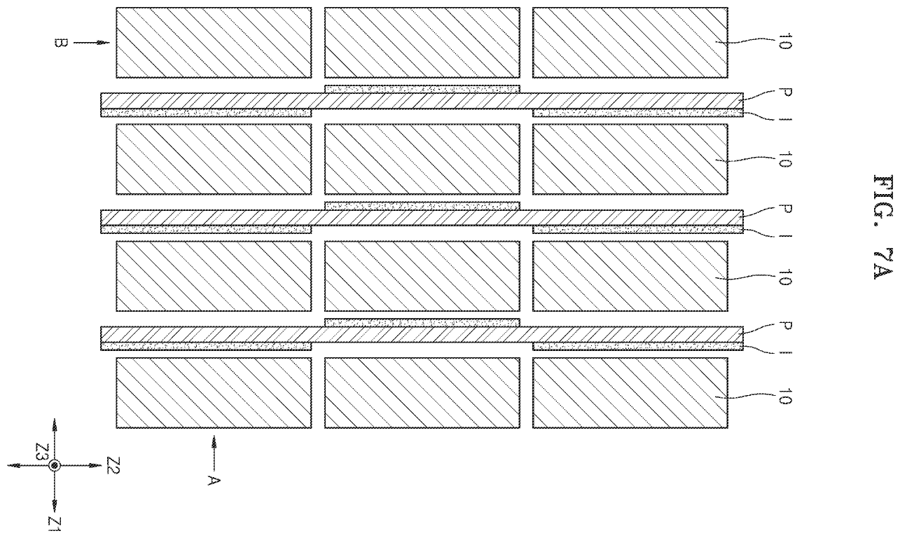

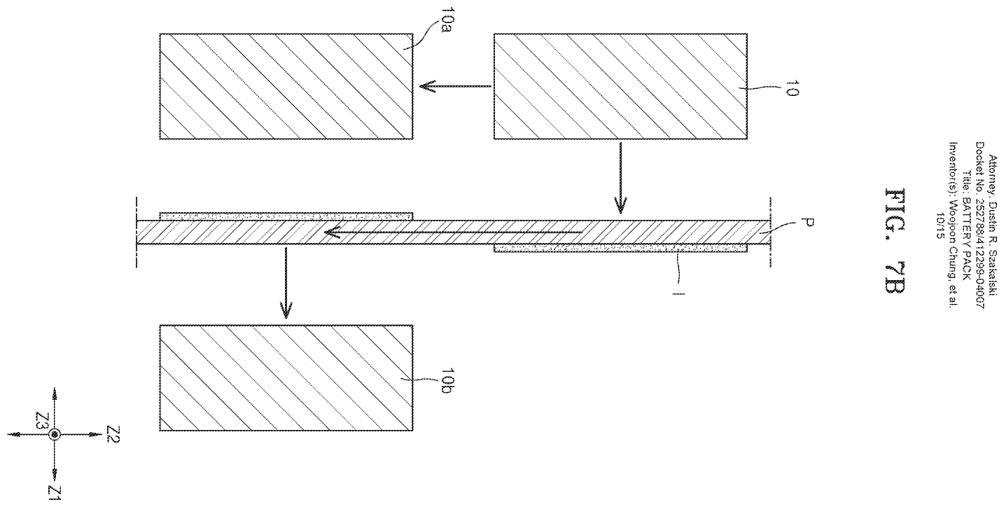

FIG. 7A is a view illustrating an arrangement of battery cells 10, cooling plates P, and heat insulation sheets I in a battery pack according to embodiments of the present disclosure.

FIG. 7B is a view illustrating a portion of FIG. 7A and is a view illustrating a heat flow between adjacent battery cells.

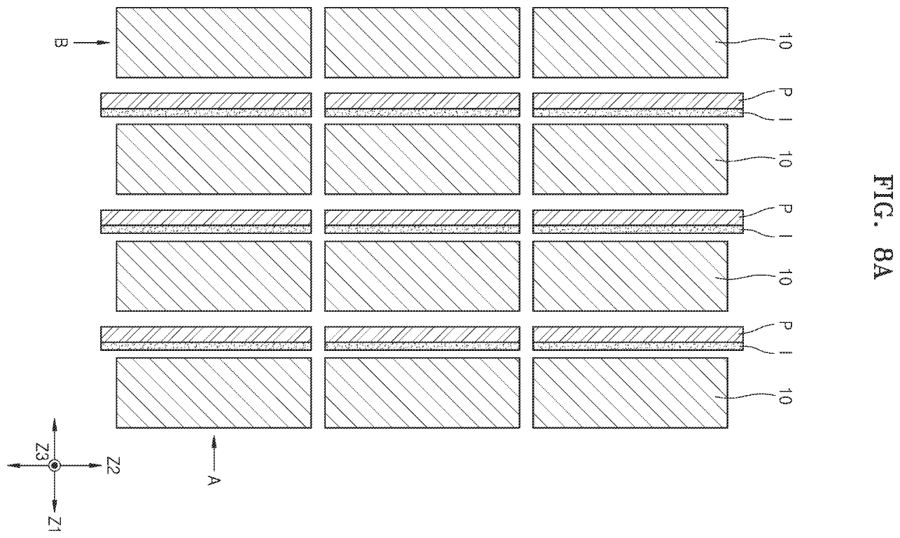

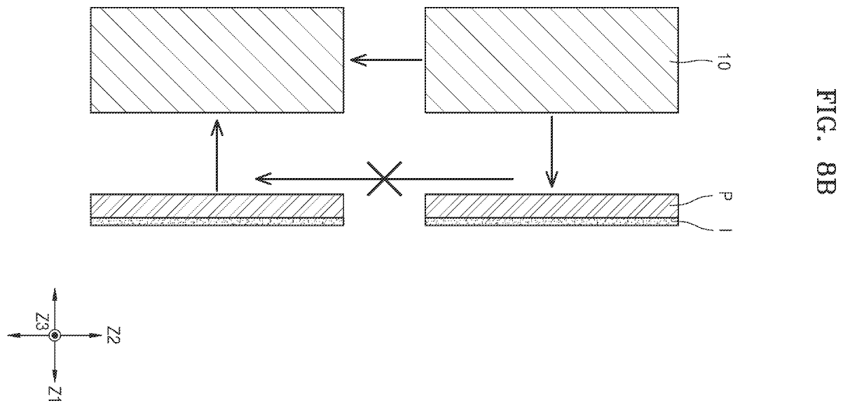

FIG. 8A is a view illustrating an arrangement of battery cells 10, cooling plates P, and heat insulation sheets I in a battery pack according to embodiments of the present disclosure.

FIG. 8B is a view illustrating a portion of FIG. 8A and is a view illustrating a heat flow between adjacent battery cells.

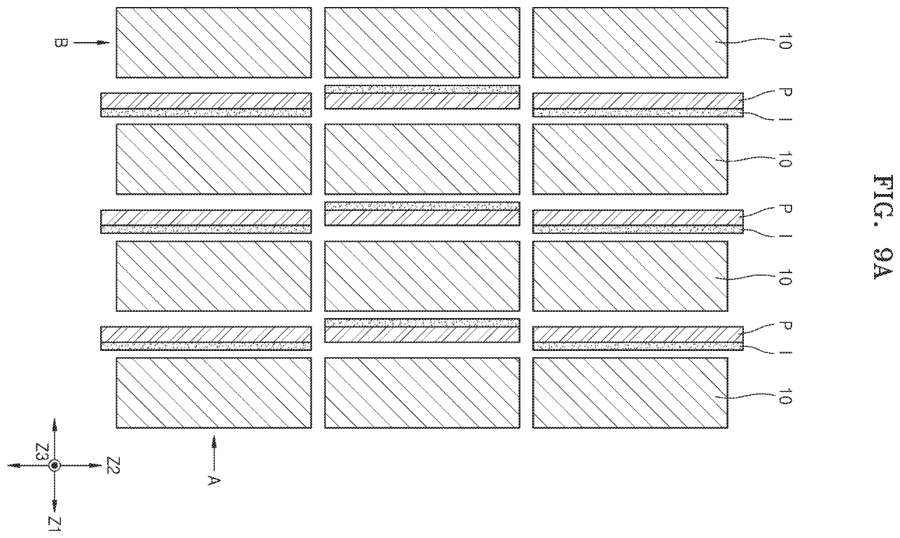

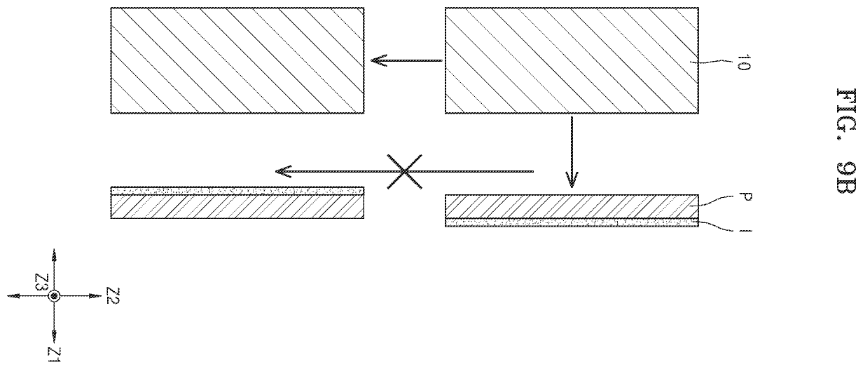

FIG. 9A is a view illustrating an arrangement of battery cells 10, cooling plates P, and heat insulation sheets I in a battery pack according to embodiments of the present disclosure.

FIG. 9B is a view illustrating a portion of FIG. 9A and is a view illustrating a heat flow between adjacent battery cells.

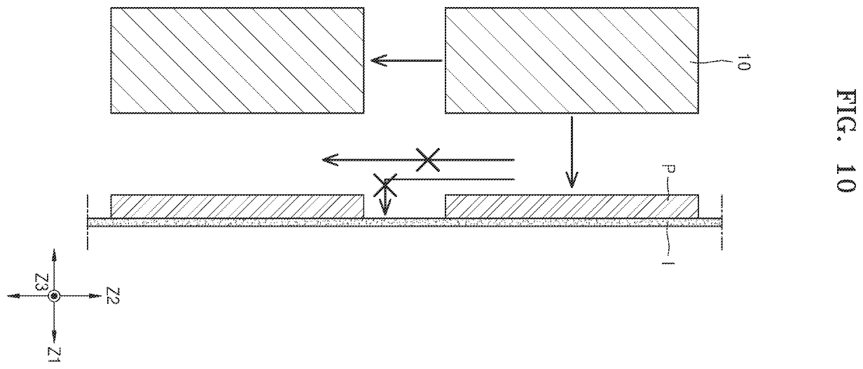

FIG. 10 is a view illustrating an arrangement of a battery cell 10, a cooling plate P, and a heat insulation sheet I in a battery pack according to embodiments of the present disclosure.

Referring to the drawings, a battery pack according to embodiments of the present disclosure may include a plurality of battery cells 10 arranged in a first direction Z1 and a second direction Z2 that intersect each other (e.g., the battery cells 10 may be arranged in a grid of rows and columns). In one or more embodiments, the battery pack may include the plurality of battery cells 10 that are two-dimensionally arranged in the first direction Z1 and the second direction Z2 on a base frame 100. The base frame 100 may form a common support base for the plurality of battery cells 10 arranged in the first and second directions Z1 and Z2 that are different from each other, e.g., the base frame 100 may be arranged at lower locations of the plurality of battery cells 10 in a third direction Z3 that is different from the first and second directions Z1 and Z2. In one or more embodiments, the first, second, and third directions Z1, Z2, and Z3 may refer to directions that intersect one another, e.g., may refer to directions that perpendicularly intersect one another (e.g., mutually orthogonal axes).

Referring to FIG. 3, each of the plurality of battery cells 10 forming the battery pack may include a pair of main surfaces 15 occupying relatively greatest areas, an upper surface 13 and a lower surface 14, which connect the pair of main surfaces 15 to each other and form long side portions extending relatively long (e.g., long edges), and first and second side surfaces 11 and 12 which form short side portions extending relatively short. In one or more embodiments, the pair of main surfaces 15 may refer to surfaces of the battery cell 10 facing each other in the first direction Z1, the pair of first and second side surfaces 11 and 12 may refer to surfaces of the battery cell 10 facing each other in the second direction Z2, and the pair of upper surface 13 and lower surface 14 may face each other in the third direction Z3 that intersects the first and second directions Z1 and Z2. In one or more embodiments, the first and second side surfaces 11 and 12 may occupy the smallest areas from among the battery cell 10, and the first and second side surfaces 11 and 12 may face each other between adjacent battery cells 10 forming the same column B in the second direction Z2 in which the cooling plate P and the heat insulation sheet I extend. The cooling plate P and the heat insulation sheet I may electrically connect the adjacent battery cells 10 forming the same column B in the second direction Z2 through a connection between first and second electrodes E1 and E2 formed on the first and second side surfaces 11 and 12.

In one or more embodiments, a plurality of battery cells 10 may be arranged in the first and second directions Z1 and Z2, and in one or more embodiments, the first direction Z1 may refer to a direction in which the main surfaces 15 of the battery cells 10 are arranged adjacent to each other face each other, and the second direction Z2 may refer to a direction in which the first and second side surfaces 11 and 12 of the adjacent battery cells 10 are arranged adjacent to face each other. In one or more embodiments, a plurality of battery cells 10 forming a battery pack may be two-dimensionally arranged in the first direction Z1 and the second direction Z2, and adjacent battery cells 10 may be arranged in the first direction Z1 so that the main surfaces 15 face each other, and adjacent battery cells 10 may be arranged in the second direction Z2 so that the first and second side surfaces 11 and 12 face each other. In the first direction Z1, adjacent battery cells 10 may be arranged to face each other through the main surfaces 15, and in the second direction Z2, adjacent battery cells 10 may be arranged to face each other through the first and second side surfaces 11 and 12. In one or more embodiments, a plurality of battery cells 10 forming the battery pack may include battery cells 10 in a plurality of rows A, which are arranged in the first direction Z1, and battery cells 10 in a plurality of columns B, which are arranged in the second direction Z2, and may be two-dimensionally arranged while forming the plurality of rows A and the plurality of columns B in the first and second directions Z1 and Z2. Accordingly, the first and second directions Z1 and Z2 may refer to a direction of the row A and a direction of the column B of the plurality of battery cells 10 that are two-dimensionally arranged.

In one or more embodiments, the cooling plate P and the heat insulation sheet I may be arranged between battery cells 10 adjacent to each other in the first direction Z1. The cooling plate P and the heat insulation sheet I may be formed to have opposing thermal behaviors, e.g., the cooling plate P may be applied to strengthen or promote a thermal flow with the battery cell 10, and the heat insulation sheet I may be applied to block or suppress (or at least mitigate) a thermal flow with the battery cell 10. In one or more embodiments, the cooling plate P and the heat insulation sheet I may be arranged to overlap each other between battery cells 10 adjacent to each other in the first direction Z1, e.g., the cooling plate P and the heat insulation sheet I may be located between main surfaces 15 of battery cells 10, which are adjacent to each other in the first direction Z1 so that main surfaces 15 occupying greatest areas face each other. In one or more embodiments, the cooling plate P and the heat insulation sheet I may be located between main surfaces 15 of battery cells 10 adjacent to each other in the first direction Z1 and may be in direct contact with each other or may be coupled to each other without another component (other than a coupler such as tape, adhesive, or the like) therebetween. As described above, the cooling plate P and the heat insulation sheet I having the opposing thermal behaviors may be in direct contact with or be coupled to each other without another component therebetween, and accordingly, a distance between adjacent battery cells 10 may be reduced while blocking cooling and heat propagation between adjacent battery cells 10. Thus, a battery pack having a high energy density may be provided and a battery pack having high power and high capacity compared to the same area may be provided, by reducing a distance between the battery cells 10 adjacent to each other in the first direction Z1. As described above, in one or more embodiments, between battery cells 10 adjacent to each other in the first direction Z1, the cooling plate P and the heat insulation sheet I may be in direct contact with or be coupled to each other without another component therebetween, e.g., a component other than a coupler (e.g., a tape, adhesive, or the like) for location fixation or coupling of the cooling plate P and the heat insulation sheet I between battery cells 10 adjacent to each other in the first direct Z1 may not be included between the adjacent battery cells 10. In one or more embodiments, the cooling plate P and the heat insulation sheet I may be located between battery cells 10 adjacent to each other in the first direction Z1, and a single cooling plate P and a single heat insulation sheet I may be located between the battery cells 10 adjacent to each other in the first direction Z1. In one or more embodiments, two or more cooling plates P or two or more heat insulation sheets I, which perform substantially the same function, may not be located between battery cells 10 adjacent to each other in the first direction Z1, and as described above, two or more of any one component from among the cooling plate P and the heat insulation sheet I, which have substantially opposing thermal behaviors, may not overlap each other for the same cooling and heat insulation.

In one or more embodiments, the cooling plate P and the heat insulation sheet I may be located while maintaining the same arrangement order and relationship between main surfaces 15 of battery cells 10 arranged adjacent to each other in the first direction Z1. In one or more embodiments, the cooling plate P and the heat insulation sheet I may be arranged so that a relative arrangement between any one battery cell 10 (CO) and the adjacent front battery cell CF and a relative arrangement between the one battery cell 10 (CO) and the adjacent rear battery cell CR are asymmetric to each other in the first direction Z1 on the basis of the one battery cell 10 (CO). In one or more embodiments, the cooling plate P and the heat insulation sheet I may be asymmetrically arranged on the basis of the one battery cell 10 (CO). In one or more embodiments, the cooling plate P and the heat insulation sheet I may be asymmetrically arranged between the one battery cell 10 (CO) and the adjacent front battery cell CF and between the one battery cell 10 (CO) and the adjacent rear battery cell CR. In one or more embodiments, the cooling plate P and the heat insulation sheet I may be arranged so that a relative order between the cooling plate P and the heat insulation sheet I arranged between the one battery cell 10 (CO) and the adjacent front battery cell CF and a relative order between the cooling plate P and the heat insulation sheet I arranged between the one battery cell 10, (CO) and the adjacent rear battery cell CR are reversed with respect to each other. In one or more embodiments, if the heat insulation sheet I is arranged close to the adjacent front battery cell CF and the cooling plate P is arranged away from the adjacent front battery cell CF, on the basis of the one battery cell 10 (CO), the cooling plate P may be arranged close to the adjacent rear battery cell CR and the heat insulation sheet I may be arranged away from the adjacent rear battery cell CR. The cooling plate P and the heat insulation sheet I may be arranged so that the cooling plate P and the heat insulation sheet I arranged between the one battery cell 10 (CO) and the adjacent front battery cell CF and the cooling plate P and the heat insulation sheet I arranged between the one battery cell 10 (CO) and the adjacent rear battery cell CR have an asymmetric location relationship on the basis of the one battery cell 10 (CO).

The cooling plate P and the heat insulation sheet I may be located while maintaining the same arrangement order and relationship in the first direction Z1, and accordingly, a location arrangement of the cooling plate P and heat insulation sheet I, which are assembled while maintaining the same order and relationship between a plurality of battery cells 10, may be more easily made if assembling a battery pack, and a battery pack, which may be easily automatized, may be provided. In one or more embodiments, if the cooling plate P and the heat insulation sheet I are arranged in the order of the cooling plate P and the heat insulation sheet I between the one battery cell 10 (CO) and the adjacent front battery cell CF in the first direction Z1, the cooling plate P and the heat insulation sheet I may be arranged in the order of the cooling plate P and the heat insulation sheet I even between the one battery cell 10 (CO) and the adjacent rear battery cell CR. As described below, in various embodiments, the cooling plate P and the heat insulation sheet I being arranged while maintaining the same arrangement order and relationship in the first direction Z1 may indicate that the cooling plate P and the heat insulation sheet I maintain the same relationship in the first direction Z1 between adjacent battery cells 10 forming the same row A, between a plurality of battery cells 10 forming the same row A while arranged in the first direction Z1, and in various embodiments described below, the cooling plate P and the heat insulation sheet I may be arranged in an arrangement order of different relationships between adjacent battery cells 10 forming different columns. In one or more embodiments, with respect to the battery cells 10 in columns B adjacent to each other in the second direction Z2, the cooling plate P and the heat insulation sheet I may maintain the same arrangement order and relationship between adjacent battery cells 10 forming the same respective columns. In one or more embodiments, the cooling plate P and the heat insulation sheet I may maintain the same arrangement order and relationship between adjacent battery cells 10 of battery cells 10 in one column B and between adjacent battery cells 10 in adjacent columns B. However, the arrangement order and relationship between the cooling plate P and the heat insulation sheet I between the adjacent battery cells 10 of the battery cells 10 in the one column B may be different from the arrangement order and relationship of the cooling plate P and the heat insulation sheet I between the adjacent battery cells 10 of the battery cells 10 in the adjacent columns B.

In one or more embodiments, the cooling plate P and the heat insulation sheet I, which are arranged while maintaining the same arrangement order and relationship in the first direction Z1, may exhibit high performance in two opposing aspects of cooling (promotion of heat flow) and heat insulation (blocking of heat propagation or suppression of heat flow) between battery cells 10 adjacent to each other in the first direction Z1.

In one or more embodiments, the cooling plate P and the heat insulation sheet I, which are arranged while maintaining the same arrangement order and relationship in the first direction Z1, may effectively block thermal runaway to the front battery cell CF and the rear battery cell CR adjacent to both sides of the one battery cell 10 (CO), if any one battery cell 10 (CO) from among a plurality of battery cells 10 overheats. In one or more embodiments, the thermal runaway from the one battery cell 10 (CO) may be blocked from the heat insulation sheet I located between the one battery cell 10 (CO) and the adjacent front battery cell CF and the heat insulation sheet I located between the one battery cell 10 (CO) and the adjacent rear battery cell CR, and if the thermal runaway is understood as a surface phenomenon in which heat is rapidly transferred through main surfaces 15 between adjacent battery cells 10, the thermal runaway from the one battery cell 10 (CO) may be blocked from the heat insulation sheet I located between the one battery cell 10 (CO) and the adjacent front battery cell CF and the heat insulation sheet I located between the one battery cell 10 (CO) and the adjacent rear battery cell CR. In one or more embodiments, with respect to the overheated one battery cell 10 (CO) and the adjacent front battery cell CF, overheating from the one battery cell 10 (CO) may be blocked from the heat insulation sheet I adjacent to the one battery cell 10 (CO), (e.g., from the heat insulation sheet I arranged at a short distance location from (proximate) the one battery cell 10 (CO)). With respect to the one battery cell 10 (CO) and the adjacent rear battery cell CR, the cooling plate P arranged adjacent to the one battery cell 10 (CO) (e.g., the cooling plate P arranged at a short distance location from (proximate) the one battery cell 10 (CO)), may not interfere with heat blocking by the heat insulation sheet I arranged further from the overheated one battery cell 10 (CO), and heat transferred through the cooling plate P from the overheated one battery cell 10 (CO) may be blocked by the heat insulation sheet I, and thus heat propagation from the overheated one battery cell 10 (CO) to the adjacent rear battery cell CR may be blocked.

In one or more embodiments, the cooling plate P and the heat insulation sheet I, which are arranged while maintaining the same arrangement order relationship in the first direction Z1, may effectively cool any one battery cell 10 (CO) from among a plurality of battery cells 10. In one or more embodiments, with respect to the one battery cell 10 (CO) and the adjacent rear battery cell CR, heat from the one battery cell 10 (CO) may be removed through the cooling plate P adjacent to the one battery cell 10 (CO), (e.g., the cooling plate P arranged at a short distance location from (proximate) the one battery cell 10 (CO)), and heat from the one battery cell 10 (CO) CO may be transferred through the main surface 15, which occupies a relatively great area from among the one battery cell 10 (CO), toward the cooling plate P arranged adjacent to the one battery cell 10 (CO), e.g., toward the cooling plate P arranged at a short distance location from the one battery cell 10 (CO) With respect to the one battery cell 10 (CO) and the adjacent rear battery cell CR, the heat insulation sheet I arranged adjacent to the one battery cell 10 (CO), (e.g., the heat insulation sheet I arranged at a short distance location from (proximate) the one battery cell 10 (CO)), may interfere with heat transfer to the cooling plate P away from (spaced apart from) the one battery cell 10 (CO). However, heat from the one battery cell 10 (CO) may be sufficiently removed through the cooling plate P located between the one battery cell 10 (CO) and the adjacent rear battery cell CR rather than through the cooling plate P located between the one battery cell 10 (CO) and the adjacent front battery cell CF. The cooling plate P may have a limited heat capacity and a cooling load of the cooling plate P may be equally distributed (or substantially equally distributed) as a whole by limiting a cooling load allocated to each cooling plate P to the battery cell 10 having the main surface 15 arranged at a short distance location from the corresponding cooling plate P. In a comparative example contrasting with the present disclosure, even if heat from the corresponding battery cell 10 is removed through the cooling plates P arranged adjacent to the main surfaces 15 on both sides of each battery cell 10, a difference may not occur in a heat removal ability of the entire battery pack if heat is accepted on one side of the cooling plate P or on both sides of the cooling plate P according to the limited heat capacity of the cooling plate P, but a heat distribution issue may occur between each battery cell 10 and each cooling plate P. For instance, a heat capacity of the cooling plate P may need allocation of a space with an increase in a size of the cooling plate P or a cooling circuit connected to the cooling plate P such as an accommodation capacity of a cooling medium accommodated in the cooling plate P or a flow rate of a fluid pump for circulation of the cooling medium (the cooling circuit), and thus, the cooling plate P, which is set to an appropriate cooling load, may have some degree of heat capacity limitation. Therefore, in one or more embodiments, for a heat distribution between each battery cell 10 and each cooling plate P, a cooling load allocated to each cooling plate P may be limited to the battery cell 10 (e.g., the battery cell 10 arranged on one side of the cooling plate P in the first direction Z1, rather than on both sides of the cooling plate P) having the main surface 15 arranged at a short distance location from a front surface or a rear surface of each cooling plate P, and each cooling plate P may accommodate heat of the battery cell 10 through one side location thereof (e.g., the battery cell 10 on any one side from among the battery cells 10 on both sides in the first direction Z), rather than through both side locations (the battery cells 10 on both sides in the first direction Z) in the first direction Z1.

With respect to cooling of the one battery cell 10 (CO), the cooling plate P located between the one battery cell 10 (CO) and the adjacent rear battery cell CR arranged at a relatively short distance location may accommodate a significant amount of heat from the one battery cell 10 (CO), and the cooling plate P located between the one battery cell 10 (CO) and the adjacent front battery cell CF arranged at a relatively long distance location may accommodate a relatively small amount of heat transferred through the heat insulation sheet I located between the one battery cell 10 (CO) and the adjacent front battery cell CF arranged at a relatively short distance location. As described above, in one or more embodiments, asymmetric cooling may be implemented through the cooling plates P and the heat insulation sheets I which are asymmetrically arranged on front and rear sides in the first direction Z1 on the basis of any one battery cell 10 (CO) from among a plurality of battery cells 10 (e.g., a considerable amount of heat may be removed through one main surface 15 of the one battery cell 10 (CO) while a relatively small amount of heat may be removed through the other main surface 15 of the one battery cell 10 (CO)).

In one or more embodiments, the cooling plate P may increase a cooling area while arranged to face the main surface 15 of the battery cell 10 occupying a relatively great area, and cooling efficiency of the battery cell 10 may be improved through a relatively large cooling area between the main surface 15 of the battery cell 10 and the cooling plate P.

In one or more embodiments, any one main surface 15 (corresponding to a heat transfer surface described below) from among front and rear surfaces, which form the main surfaces 15 of the one battery cell 10 (CO), may be located relatively adjacent to the cooling plate P from among the cooling plate P and the heat insulation sheet I, and the other main surface 15 (corresponding to a heat insulation surface described below) may be located relatively adjacent to the heat insulation sheet I from among the cooling plate P and the heat insulation sheet I. As described herein, the battery cell 10 may include a heat transfer surface and a heat insulation surface as a pair of main surfaces 15 facing each other in the first direction Z1 in which the battery cell 10 is arranged, the heat transfer surface of the battery cell 10 may refer to a surface relatively adjacent to the cooling plate P from among the cooling plate P and the heat insulation sheet I, and the heat insulation surface of the battery cell 10 may refer to a surface relatively adjacent to the heat insulation sheet I from among the cooling plate P and the heat insulation sheet I. In one or more embodiments, the heat transfer surface and the heat insulation surface of the battery cell 10 may be understood as being defined or classified according to a relative distance relationship between the cooling plate P and the heat insulation sheet I, which are components adjacent to the battery cell 10, rather than as classification according to the structure or configuration of the battery cell 10. In one or more embodiments, each battery cell 10 including the heat transfer surface and the heat insulation surface as the pair of main surfaces 15 facing each other in the first direction Z1 in which the battery cell 10 is arranged may indicate that both the pair of main surfaces 15 of the battery cell 10 form the heat transfer surface or both the pair of main surfaces 15 of the battery cell 10 do not form the heat insulation surface. In one or more embodiments, each battery cell 10 including the heat transfer surface and the heat insulation surface as the pair of main surfaces 15 facing each other in the first direction Z1 in which the battery cell 10 is arranged may indicate that respective battery cells 10 forming a battery pack may face the cooling plate P through the heat transfer surface and face the heat insulation sheet I through the heat insulation surface. In one or more embodiments, any one battery cell 10 (CO) from among a plurality of battery cells 10 may generate a relatively large amount of heat flow through the heat transfer surface that is the main surface 15 facing the cooling plate P and block a heat flow or allow only a limited heat flow through the heat insulation surface that is the main surface 15 facing the heat insulation sheet I.

Referring to FIG. 5B, in one or more embodiments, the cooling plate P and the heat insulation sheet I, which are arranged while maintaining the same arrangement order and relationship in the first direction Z1, may extend in the second direction Z2 across between battery cells 10 arranged adjacent to each other in the first direction Z1 and may extend over a plurality of battery cells 10, which are arranged in the second direction Z2 and form the same column B. In one or more embodiments, by integrally forming the cooling plate P and the heat insulation sheet I, the cooling plate P and the heat insulation sheet I may be assembled to extend over a plurality of battery cells 10 forming respective columns B between battery cells 10 in adjacent columns B arranged in the second direction Z2, without needing to consider location arrangement between the cooling plate P and the heat insulation sheet I and each battery cell 10, and a location arrangement with each battery cell 10 does not need to be considered to assemble the cooling plate P and the heat insulation sheet I by arranging the cooling plate P and the heat insulation sheet I (e.g., alternate location reversals are not needed to assemble the cooling plate P and the heat insulation sheet I) while maintaining the same arrangement order and relationship in the first direction Z1 and forming the cooling plate P and the heat insulation sheet I in an integrated structure, and accordingly, an assembling process for the cooling plate P and the heat insulation sheet I may be easily performed. In one or more embodiments, the cooling plate P may be connected to a cooling circuit including a heat exchanger, and a tubular structure for a fluid connection with the cooling circuit may need to be formed. Thus, the complexity of a structure, which is needed for connecting a plurality of tube bodies to the cooling plates P in the form of discrete disconnected units of a plurality of battery cells 10 forming the same column B in the second direction Z2, may be avoided by forming the cooling plate P having an integrated structure and extending across a plurality of battery cells 10 forming the same column B in the second direction Z2 and thereby simplifying the structure for the fluid connection.

As described above, in the embodiment shown in FIG. 5B, the cooling plate P and the heat insulation sheet I may be arranged between main surfaces 15 of battery cells 10 adjacent to each other in the first direction Z1, and in a battery pack including a plurality of battery cells 10 two-dimensionally arranged in the first direction Z1 and the second direction Z2 intersecting the first direction Z1 (e.g., a grid of rows and columns), the cooling plate P and the heat insulation sheet I may each be integrally formed over a plurality of battery cells 10, which are arranged in the second direction Z2 and form the same column B.

As described below, in various embodiments, at least one of the cooling plate P and the heat insulation sheet I may be integrally formed over a plurality of battery cells 10, which are arranged in the second direction Z2 and form the same column B, or may be formed in a divided form with respect to each of a plurality of battery cells 10 forming the same column B in the second direction Z2, and the other of the cooling plate P and the heat insulation sheet I may also be integrally formed over a plurality of battery cells 10, which are arranged in the second direction Z2 and form the same column B, or may be formed in a divided form with respect to each of a plurality of battery cells 10 forming the same column B in the second direction Z2. As described above, in various embodiments, with respect to battery cells 10 in the same column B, which are arranged in the second direction Z2 and have first and second side surfaces 11 and 12 facing each other, the cooling plate P and the heat insulation sheet I may integrally extend with respect to battery cells 10 in the same column B or may be formed in a divided form with respect to respective battery cells 10 in the same column B, and with respect to battery cells 10 in the same row A, which are arranged in the first direction Z1 and have main surfaces 15 facing each other, the cooling plate P and the heat insulation sheet I may be formed in a disconnected form with respect to each of a plurality of battery cells 10 forming the same row A. In one or more embodiments, if the cooling plate P and the heat insulation sheet I integrally extend over a plurality of battery cells 10 forming the same row A while main surfaces 15 occupying relatively great areas, e.g., the greatest areas, face each other from among battery cells 10 forming a battery pack, a significant degree of thermal interference or a chain of thermal runaway may occur between a plurality of battery cells 10 forming the same row A with the cooling plate P and the heat insulation sheet I therebetween.

Referring to FIG. 6B, in various embodiments, at least one of the cooling plate P and the heat insulation sheet I may be formed in a divided form with respect to each of a plurality of battery cells 10 forming the same column B in the second direction Z2, rather than being integrally formed over the plurality of battery cells 10, which are arranged in the second direction Z2 and form the same column B. As illustrated in FIG. 6B, the cooling plate P may be integrally formed over a plurality of battery cells 10, which are arranged in the second direction Z2 and form the same column B, but the heat insulation sheet I may be formed in a divided form with respect to each of a plurality of battery cells 10, which are arranged in the second direction Z2 and form the same column B. In the embodiment described above, the cooling plates P may be integrally formed over a plurality of battery cells 10, which are arranged in the second direction Z2 and form the same column B, may include a plurality of cooling plates P arranged in the first direction Z1, and may be formed in a divided form with respect to each of a plurality of battery cells 10, which are arranged in the first direction Z1 and form the same row A, while extending over a plurality of battery cells 10, which are arranged in the second direction Z2 and form the same column B. Unlike the cooling plate P described above, the heat insulation sheets I may be divided with respect to each of a plurality of battery cells 10, which are arranged in the second direction Z2 and form the same column B, and simultaneously, may be divided with respect to each of a plurality of battery cells 10, which are arranged in the first direction Z1 and form the same row A. As a result, the heat insulation sheets I may be individually divided in units of respective battery cells 10 forming a battery pack. In one or more embodiments, any one of the cooling plate P and the heat insulation sheet I may extend over a plurality of battery cells 10 forming the same column B in the second direction Z2, and the other one may be formed in a divided form with respect to each of a plurality of battery cells 10 forming the same column B in the second direction Z2. In the embodiment shown in FIG. 6B, unlike the heat insulation sheet I that does not need a connection structure with the outside, the cooling plates P, which may utilize a tubular structure for a fluid connection with a cooling circuit including a heat exchanger, may integrally extend over a plurality of battery cells 10 forming the same column B in the second direction Z2, and thus the complexity of a structure connecting a plurality of tube bodies together may be avoided.

Referring to FIGS. 5B and 6B, in relation to the cooling plate P which integrally extends over a plurality of battery cells 10 which are arranged in the second direction Z1 and form the same column B, the heat insulation sheet I may be arranged on any one main surface from among main surfaces on both sides of the cooling plate P in the first direction Z1, e.g., from among main surfaces occupying the greatest areas from among the cooling plate P, and the other main surface may be exposed toward the battery cell 10 by excluding the heat insulation sheet I therefrom. In relation to a location at which the heat insulation sheet I is arranged, the heat insulation sheet I may be arranged on a main surface of the cooling plate P, (e.g., a front surface or a rear surface of the cooling plate P forming any one main surface from among the main surfaces occupying the greatest areas of the cooling plate P), and the main surface of the cooling plate P may face a plurality of battery cells 10, which are arranged in the second direction Z2 and form the same column B, with the heat insulation sheet I between cooling plate P and the battery cells 10 in the same column B. In this regard, the other main surface of the cooling plate P, which is exposed by excluding the heat insulation sheet I from the rear surface or the front surface of the cooling plate P forming the other main surface of the cooling plate P, may face a plurality of battery cells 10, which are arranged in the second direction Z2 and form the same column B, without the heat insulation sheet I therebetween. In one or more embodiments, a plurality of battery cells 10, which are arranged in the second direction Z2 to form the same column B and face the main surface of the cooling plate P exposed by excluding the heat insulation sheet I therefrom, may keep a thermal balance with each other through a heat flow passing through the cooling plate P. In one or more embodiments, heat of the overheated battery cell 10 may be dispersed toward other battery cells 10, which belong to the same column B, through a heat flow passing through the cooling plate P, and thus, overheating of the battery cell 10 may be alleviated. As described above, in the embodiments illustrated in FIGS. 5B and 6B, a plurality of heat insulation sheets I spaced apart from each other may be arranged on one of the main surfaces (e.g., the front surface or the rear surface) of the cooling plate P that extends in the second direction Z2 and is formed over a plurality of battery cells 10 forming the same column B, and thus, a plurality of battery cells 10, which form the same column B in the second direction Z2, may maintain a thermal balance through a heat flow passing through the cooling plate P while facing the front surface or the rear surface of the cooling pate P exposed by excluding the heat insulation sheet I therefrom.

Referring to FIG. 7B, in relation to the cooling plate P extending over a plurality of battery cells 10 which are arranged in the second direction Z1 and form the same column B, the heat insulation sheets I may be arranged on the main surface on any one side from among the main surfaces on both sides of the cooling plate P in the first direction Z1, (e.g., from among the main surfaces occupying the greatest areas of the cooling plate P), and the main surface on the other side may be exposed toward the battery cell 10 by excluding the heat insulation sheet I therefrom. In relation to locations at which the heat insulation sheets I are arranged, the heat insulation sheets I may be formed on a front surface and a rear surface of the cooling plate P to alternate with each other in the second direction Z2 (e.g., the heat insulation sheets I may be alternately arranged on opposite main surfaces of the cooling plate P). As described above, the heat insulation sheets I may alternate with each other on the front surface and the rear surface of the cooling plate P extending in the second direction Z2, and thus, heat propagation to another adjacent battery cell 10 if any one battery cell 10 (CO) overheats may be effectively blocked. In one or more embodiments, a plurality of battery cells 10 forming the battery pack may be two-dimensionally arranged in the first and second directions Z1 and Z2, and the heat insulation sheet I may be arranged between main surfaces 15 of battery cells 10 adjacent to each other in the first direction Z1, (i.e., between main surfaces 15 occupying relatively great areas, e.g., the greatest areas), and thus, the battery cells 10 adjacent to each other in the second direction Z2 may arranged to face each other without the heat insulation sheet I between first and second side surfaces 11 and 12 of the battery cells 10, (e.g., between the first and second side surfaces 11 and 12 occupying the smallest areas). As described above, in one or more embodiments, the heat insulation sheet I may be arranged toward the main surface 15 occupying a relatively great area, e.g., the greatest area, but the heat insulation sheets I may not be arranged toward the first and second side surfaces 11 and 12 occupying relatively small areas, e.g., the smallest areas, of the battery cells 10. Therefore, heat propagation may be kept in balance to a certain degree through the main surfaces 15 and the first and second side surfaces 11 and 12 of the overheated battery cell 10, and in the embodiment illustrated in 7B, heat propagation passing through the cooling plate P from the main surface 15 of the overheated battery 10 occupying a relatively great area and direct heat propagation from the first and second side surfaces 11 and 12 of the overheated battery cell 10 occupying relatively small areas may be directed toward different battery cells 10, and thus, a chain of thermal runaway, which is caused by heat propagation directed from the overheated battery cell 10 toward a particular adjacent battery cell 10, may be prevented.

In the embodiments of FIGS. 5B and 6B, heat propagation, which passes through the cooling plate P from the main surface 15 of the overheated battery cell 10 occupying a relatively great area, e.g., the greatest area, and direct heat propagation from the first and second side surfaces 11 and 12 of the overheated battery cell 10 occupying relatively small areas, e.g., the smallest areas, may be concentrated toward the battery cell 10 in the same column B as the overheated battery cell 10 in the second direction Z2, and thus, a chain of thermal runaway may occur. However, in the embodiment of FIG. 7B, heat propagation through different paths from the overheated battery cell 10 may be prevented from being concentrated toward the battery cell 10 in the same column B in the second direction Z2 by alternating the heat insulation sheets I on the front surface and the rear surface of the cooling plate P extending in the second direction Z2, e.g., heat propagation through different paths from the overheated battery cell 10 may be directed toward different battery cells 10. In one or more embodiments, heat propagation, which passes from the main surface 15 of the overheated battery cell 10 through the cooling plate P extending in the second direction Z2, may be transferred to the battery cells 10 (e.g., the battery cells 10b of FIG. 7B) which are alternately arranged from the overheated battery cell 10 toward the front side or back side in the first direction Z1, rather than being transferred to the battery cells 10 (e.g., the battery cells 10a of FIG. 7B) in the same column B as the overheated battery cell 10 in the second direction Z2, by alternately arranging the heat insulation sheets I on the front surface and the rear surface of the cooling plate P along the main surface 15 in the second direction Z2 (e.g., heat may propagate in a staggered direction from the battery cell 10 to the battery cell 10b which are in different rows and columns). In one or more embodiments, heat propagation, which passes from the main surface 15 of the overheated battery cell 10 through the cooling plate P extending in the second direction Z2, may be directed toward the battery cell 10 (e.g., the battery cell 10b of FIG. 7B) arranged diagonal with respect to the overheated battery cell 10 in the first and second directions Z1 and Z2. In contrast, direct heat propagation from the first and second side surfaces 11 and 12 of the overheated battery cell 10 may be directed toward the battery cell 10 (e.g., the battery cell 10a of FIG. 7B) in the same column B as the overheated battery cell 10 in the second direction Z2. As a result, heat propagation, which passes from the main surface 15 of the overheated battery cell 10 through the cooling plate P, may be directed toward the battery cell 10 (e.g., the battery cell 10b of FIG. 7B) arranged diagonal with respect to the overheated battery cell 10 in the first and second directions Z1 and Z2, rather than being directed toward the battery cell 10 (e.g., the battery cell 10a of FIG. 7B) in the same column B as the overheated battery cell 10 in the second direction Z2, and direct heat propagation from the first and second side surfaces 11 and 12 of the overheated battery cell 10 may be directed toward the battery cell 10 (e.g., the battery cell 10a of FIG. 7B) in the same column B as the overheated battery cell 10 in the second direction Z2. Therefore, compared to the embodiments illustrated in FIGS. 5B and 6B, heat propagation, which passes through the cooling plate P from the main surface 15 of the overheated battery cell 10, and direct heat propagation from the first and second side surfaces 11 and 12 of the overheated battery cell 10 may be prevented from being concentrated toward the battery cell 10 in the same row B as the overheated battery cell 10 in the second direction Z2.

As described above, in the embodiment illustrated in FIG. 7B, the cooling plate P may integrally (or continuously) extend over a plurality of battery cells 10 forming the same column B in the second direction Z2, and the heat insulation sheets I may be alternately arranged on the front surface and the rear surface of the cooling plate P along the main surface 15, and thus, heat propagation, which passes through the cooling plate P from the main surface 15 of the overheated battery cell 10, and direct heat propagation from the first and second side surfaces 11 and 12 of the overheated battery cell 10 may not be concentrated toward the same battery cell 10. For example, heat propagation through different paths from the overheated battery cell 10 may be prevented from being concentrated toward the battery cell 10 (e.g., the battery cell 10a of FIG. 7B) in the same column B as the overheated battery cell 10 in the second direction Z1, and thus, a chain of heat and thermal runaway of the battery cell 10 in the second direction Z2, which are caused by the concentration of heat propagation through different paths from the overheated battery cell 10 toward the battery cell 10 in the same column B as the overheated battery cell 10 in the second direction Z2, may be prevented.

As described above, in the embodiment shown in FIG. 7B, the cooling plate P may extend over a plurality of battery cells 10 forming the same column B in the second direction Z2, the heat insulation sheets I may be arranged alternately on the front surface and the rear surface of the cooling plate P in the second direction Z2, and thus, the cooling plate P and the heat insulation sheets I may maintain the same arrangement order and relationship with respect to the battery cells 10 in the same row A, which are arranged in the first direction Z1, and the same relationship maintained with respect to the battery cell 10 in the same row A in the first direction Z1 may be reversed with respect to the battery cell 10 in the corresponding row A and the battery cells 10 in different rows A adjacent to each other in the second direction Z2. In one or more embodiments, the cooling plate P and the heat insulation sheet I maintaining the same arrangement order and relationship in the first direction Z1 may indicate that the cooling plate P and the heat insulation sheet I maintain the same arrangement order and relationship with respect to the battery cells 10 in the same row A, which are arranged in the first direction Z1. In one or more embodiments, as shown in FIG. 7B, the relationship between the cooling plate P and the heat insulation sheet I with respect to the battery cells 10 in different rows A, which are adjacent to each other in the second direction Z2, may be reversed, and through the alternate arrangement of the heat insulation sheets I on the front surface and the rear surface of the cooling plate P, the relationship between the cooling plate P and the insulation sheet I may be reversed with respect to the battery cells 10 in the adjacent rows A. For reference, as described herein, the column B of the battery cells 10 may refer to an arrangement of a plurality of battery cells 10 arranged in the second direction Z2 and may refer to a set of a plurality of battery cells 10 arranged in the second direction Z2 so that the first and second side surfaces 1112 occupying relatively small areas (e.g., occupying the smallest areas from among the battery cells 10) face each other. The row A of the battery cells 10 may refer to an arrangement of a plurality of battery cells 10 arranged in the first direction Z1 and may refer to a set of a plurality of battery cells 10 arranged in the first direction Z1 so that the main surfaces 15 occupying relatively great areas (e.g., occupying the greatest areas from among the battery cells 10, face each other. As described above, in one or more embodiments, the cooling plate P and

the heat insulation sheet I may maintain the same arrangement order and relationship with respect to the battery cells 10 in the same row A in the first direction Z1, and in the embodiment shown in FIG. 7B, the arrangement order and relationship between the cooling plate P and the heat insulation sheet I may be reversed with respect to the battery cells 10 in different rows A adjacent to each other in the second direction Z2. In the embodiments shown in FIGS. 5B and 6B, the cooling plate P and the heat insulation sheet I may maintain the same arrangement order and relationship with respect to the battery cells 10 in the same row A in the first direction Z1 and may maintain the same arrangement order and relationship with respect to even the battery cells 10 in different rows A adjacent to other in the second direction Z2, and the cooling plate P and the heat insulation sheet I may maintain the same relationship with respect to the battery cells 10 in the same row A in the first direction Z1 and may maintain the same relationship with respect to even the battery cells 10 in different rows A adjacent to each other in the second direction Z2.

In the embodiments of FIGS. 5B and 6B, e.g., in the embodiments in which the cooling plate P and the heat insulation sheet I maintain the same arrangement order and relationship over battery cells 10 in rows A adjacent to each other in the second direction Z2, by arranging the cooling plate P, which extends over battery cells 10 in a plurality of columns B in the second direction Z2 and arranging the heat insulation sheets I on the front surface and the rear surface of the cooling plate P along the main surface of the cooling plate P, an even temperature distribution (or a substantially even temperature distribution) may be formed through a heat flow between battery cells 10 in the same column B in the second direction Z2, e.g., battery cells 10 in the same column B in the second direction Z2 may form an even temperature distribution (or a substantially even temperature distribution) through a heat flow between main surfaces 15 of adjacent battery cells 10, which passes through the cooling plate P, and through a heat flow between first and second side surfaces 11 and 12 of the battery cells 10. In contrast, in the embodiment shown in FIG. 7B, through the cooling plate P extending over a plurality of battery cells 10 forming the same column B in the second direction Z2 and an alternating arrangement of the heat insulation sheets I that are alternatingly arranged on the front surface and the rear surface of the cooling plate P along the main surfaces of the cooling plate P, a heat flow between battery cells 10 in the same column B in the second direction Z2 may be suppressed to a certain extent. Therefore, unlike a heat flow between the first and second side surfaces 11 and 12 between the battery cells 10 in the same column B, through the alternating arrangement of the heat insulation sheets I, a heat flow between the main surfaces 15 may mainly occur between main surfaces 15 of battery cells 10 in different columns B adjacent to each other in the first direction Z1 rather than between main surfaces 15 of battery cells 10 in the same column B. As illustrated in FIG. 7B, to implement a structure of the heat insulation sheets I that are alternatingly arranged on the front surface and the rear surface of the cooling plate P along the main surfaces of the cooling plate P extending over a plurality of battery cells 10 forming the same column B in the second direction Z2, the cooling plate P may extend continuously over the plurality of battery cells forming the same column B in the second direction Z2 and the heat insulation sheets I may be arranged in a divided form with respect to the plurality of battery cells 10 forming the same column B.

In one or more embodiments, a plurality of cooling plates P and a plurality of heat insulation sheets I may be arranged in a disconnected form with respect to battery cells 10 in respective rows A arranged in the first direction Z1. The cooling plates P may extend continuously over a plurality of battery cells 10 forming the same column B in the second direction Z2, and the heat insulation sheets I may extend continuously over the plurality of battery cells 10 forming the same column B in the second direction Z2 (refer to FIG. 5B) or may be formed in a divided form with respect to the plurality of battery cells 10 forming the same column B in the second direction Z2.

Referring to FIGS. 8B and 9B, the cooling plates P may be formed in a divided form with respect to each of a plurality of battery cells 10 forming the same column B in the second direction Z2. For example, the cooling plate P may include a connection of a tube body for a fluid connection to a cooing circuit including a heat exchanger, the cooling plate P including the connection of the tube body may be integrally or continuously formed over a plurality of battery cells 10 forming a column B in the second direction Z2, and thus, the complexity of a structure due for connecting a plurality of tube bodies may be avoided.

In the embodiments of FIGS. 8B and 9B, the cooling plate P may not be connected to the cooing circuit, e.g., the fluid connection with the cooling circuit may not be need due to the natural convection cooling through low-temperature atmosphere or forced convection cooling using a cooling fan. Each unit cooling plate P may be connected to the cooling circuit through the fluid connection and may be formed in a divided form with respect to each of a plurality of battery cells 10 that are arranged in the second direction Z2 and form the same column B to avoid thermal inference and electrical inference between adjacent battery cells 10 that are arranged in the second direction Z2 and form the same column B. In one or more embodiments, the cooling plates P, which are arranged in a divided form with respect to respective battery cells 10 in respective columns B in the second direction Z2, may block (or substantially block) heat propagation between battery cells 10 in the same column B in the second direction Z2, and accordingly, a chain of thermal runaway from the overheated battery cell 10 in the second direction Z2 may be blocked (or substantially blocked). In the embodiments shown in FIGS. 8B and 9B, similar to the cooling plates P, the heat insulation sheets I may also be formed in a disconnected form with respect to each of a plurality of battery cells 10 forming the same column B in the second direction Z2, and as a result, the cooling plates P and the heat insulation sheets I may be formed in a divided form with respect to the respective battery cells 10 forming a battery pack. The cooling plates P and the heat insulation sheets I may be formed in a divided form with respect to each of a plurality of battery cells 10 forming a row A in the first direction Z1 and may be formed in a divided form with respect to each of a plurality of battery cells 10 forming a column B in the second direction Z2. The cooling plates P and the heat insulation sheets I may be formed in a divided form with respect to respective battery cells 10, and as described above, thermal interference and electrical interference between adjacent battery cells 10 may be prevented (or substantially prevented) through the cooling plates P and the heat insulation sheets I which are divided and individually formed with respect to each of a plurality of battery cells 10 forming a battery pack, e.g., a chain of thermal runaway due to overheating of any one battery cell 10 may be prevented.

In the embodiment shown in FIG. 8B, the heat insulation sheets I may be arranged in the same orientation with respect to battery cells 10 in the same column B, which are arranged in the second direction Z2, and may be arranged on the same main surfaces of the front surfaces or the rear surfaces of the cooling plates P arranged in the second direction Z2. Unlike the embodiment of FIG. 8B, in the embodiment shown in FIG. 9B, the heat insulation sheets I may be arranged in reversed orientations with respect to battery cells 10 in the same column B, which are arranged in the second direction Z2, and may be alternatingly arranged in reversed orientations on the front surface and the rear surface of the cooling plates P arranged in the second direction Z2. In the embodiment illustrated in 8B, the heat insulation sheets I may be arranged on the same main surfaces on the front surfaces or the rear surfaces of the cooling plates P arranged in the second direction Z2, and thus, ease of assembly of the cooling plates P and the heat insulation sheets I may be achieved. In the embodiment illustrated in FIG. 9B, the heat insulation sheets I may be arranged in alternating orientations on the front surface and the rear surface of the cooling plates P arranged in the second direction Z2, and thus, heat propagation from the overheated battery cell 10 may not be directed toward any one battery cell 10, e.g., the heat insulation sheets I may be alternatingly arranged so that heat propagation may not occur between battery cells 10 adjacent to each other in the second direction Z2, through different cooling plates P that are disconnected from each other but arranged adjacent to each other.

Referring to FIG. 10, the cooling plates P may be formed in a divided form with respect to each of a plurality of battery cells 10 forming the same column B in the second direction Z2, and unlike the cooling plates P, the heat insulation sheets I may be integrally or continuously formed over a plurality of battery cells 10 forming the same column B in the second direction Z2, heat propagation may be prevented (or substantially prevented) between adjacent battery cells 10 belonging to the same column B in the second direction Z2 with the heat insulation sheet I therebetween, and even if heat propagation occurs through the first and second side surfaces 11 and 12 of another battery cell 10 adjacent to the first and second side surfaces 11 and 12 of the overheated battery cell 10, e.g., through the first and second side surfaces 11 and 12 exposed from the battery cell 10 in the same column B as the overheated battery cell 10 in the second direction Z2, the battery cell 10 in another column B, which is adjacent to battery cell 10 in the corresponding column B, may block (or substantially block) heat propagation from the heat insulation sheet I continuously extending without an empty space across battery cells 10 in different columns B adjacent to each other in the first direction Z1.

In the manner described above, the present disclosure may provide a battery pack capable of preventing (or substantially preventing) heat propagation between adjacent battery cells and thereby preventing a chain of thermal runaway due to the heat propagation.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the present disclosure as defined by the following claims.

What is claimed is:

1. A battery pack comprising:
a plurality of battery cells arranged in a row extending in a first direction; and
a cooling plate and a heat insulation sheet between each pair of adjacent battery cells of the plurality of battery cells in the row, wherein an arrangement between the cooling plate and the heating insulation sheet is a same between each of the pair of adjacent battery cells in the row.

2. The battery pack as claimed in claim 1, wherein each of the adjacent battery cells of the plurality of battery cells arranged in the row in the first direction comprise main surfaces occupying a greatest area, and wherein the main surfaces face each other.

3. The battery pack as claimed in claim 1, wherein an arrangement of the cooling plate and the heat insulation sheet between one battery cell of the plurality of battery cells and an adjacent front battery cell of the plurality of battery cells is same as an arrangement of the cooling plate and the heat insulation sheet between the one battery cell and an adjacent rear battery cell of the plurality of battery cells.

4. The battery pack as claimed in claim 3, wherein a relative arrangement between the cooling plate and the heat insulation sheet between the one battery cell and the adjacent front battery cell, and a relative arrangement between the cooling plate and the heat insulation sheet between the one battery cell and the adjacent rear battery cell are asymmetrical relative to the one battery cell.

5. The battery pack as claimed in claim 3, wherein, among the cooling plate and the heat insulation sheet between the one battery cell and the adjacent front battery cell, the cooling plate is proximate to the one battery cell and the heating insulation sheet is spaced part from the one battery cell by the cooling plate, and
wherein, among the cooling plate and heat insulation sheet between the one battery cell and the adjacent rear battery cell, the heating insulation sheet is proximate to the one battery cell and the cooling plate is spaced apart from the one battery cell by the heating insulation sheet.

6. The battery pack as claimed in claim 1, wherein the plurality of battery cells are two-dimensionally arranged in a plurality of rows and a plurality of columns, each of the plurality of battery cells in the plurality of rows extending in the first direction and each of the plurality of battery cells in the plurality of columns extending in a second direction which intersects the first direction.

7. The battery pack as claimed in claim 6, wherein battery cells of the plurality of battery cells adjacent to each other in a same row of the plurality of rows in the first direction are arranged so that main surfaces occupying greatest areas from among each of the battery cells face each other, and
wherein battery cells of the plurality of battery cells adjacent to each other in a same column of the plurality of columns in the second direction are arranged so that first and second side surfaces occupying smallest areas from each of the plurality of battery cells face each other.

8. The battery pack as claimed in claim 6, wherein the cooling plate and the heat insulation sheet between each pair of adjacent battery cells among the plurality of battery cells in the row are disconnected from each other and extend continuously over the battery cells arranged in the same column of the plurality of columns in the second direction.

9. The battery pack as claimed in claim 8, wherein the battery cells arranged in the same column of the plurality of columns in the second direction are configured to generate an even heat distribution through the cooling plate.

10. The battery pack as claimed in claim 8, wherein each of the plurality of battery cells comprises:
a pair of main surfaces facing each other and occupying greatest areas; and
a pair of first and second side surfaces connecting the pair of main surfaces and facing each other and occupying smallest areas,
wherein the main surfaces of each of the plurality of battery cells arranged adjacent to each other in the same column of the plurality of columns in the second direction are thermally connected to each other through the cooling plate, and
wherein the pair of first and second side surfaces of each of the plurality of battery cells arranged adjacent to each other in the same column of the plurality of columns in the second direction are thermally connected to each other and face each other.

11. The battery pack as claimed in claim 6, wherein the cooling plate and the heat insulation sheet between each pair of adjacent battery cells of the plurality of battery cells in a same row of the plurality of rows are disconnected from each other,
wherein the cooling plate extends continuously over the battery cells arranged in a same column of the plurality of columns in the second direction, and
wherein the heat insulation sheet comprises a plurality of individual heat insulation sheets disconnected from each other with respect to each of the battery cells arranged in the same column in the second direction.

12. The battery pack as claimed in claim 11, wherein the heat insulation sheet comprises a plurality of heat insulation sheets alternately arranged on a front surface and a rear surface of the cooling plate extending along the plurality of battery cells arranged a same column of the plurality of columns in the second direction.

13. The battery pack as claimed in claim 12, wherein each of the plurality of battery cells comprises:
a pair of main surfaces facing each other and occupying greatest areas; and
a pair of first and second side surfaces connecting the pair of main surfaces and facing each other and occupying smallest areas,
wherein the pair of first and second side surfaces of the battery cells arranged adjacent to each other in a same column of the plurality of columns in the second direction are thermally connected to each other and facing each other, and
wherein the pair of main surfaces of the battery cells arranged adjacent to each other in the same column of the plurality of columns in the second direction are insulated from each other by the plurality of heat insulation sheets alternately arranged on the front surface and the rear surface of the cooling plate.

14. The battery pack as claimed in claim 6, wherein the cooling plate and the heat insulation sheet between each of the battery cells arranged in a same row of the plurality of rows in the first direction are disconnected from each other,
wherein the heat insulation sheet between each of the battery cells arranged in the same row extends continuously over the battery cells arranged in a same column of the plurality of columns in the second direction, and
wherein the cooling plate between each of the battery cells in the same row comprises a plurality of individual cooling plates disconnected from each other with respect to each of the battery cells arranged in the same column of the plurality of columns in the second direction.

15. The battery pack as claimed in claim 14, wherein each of the plurality of battery cells comprises:
a pair of main surfaces facing each other and occupying greatest areas; and
a pair of first and second side surfaces connecting the pair of main surfaces and facing each other and occupying smallest areas,
wherein the pair of first and second side surfaces of the battery cells arranged adjacent to each other in a same column of the plurality of columns in the second direction are thermally connected to each other and face each other,
wherein a heat flow between the pair of main surfaces of the battery cells arranged adjacent to each other in the same column of the plurality of columns in the second direction is disconnected from the plurality of individual cooling plates that are disconnected from each other with respect to each of the battery cells arranged in the same column of the plurality of columns, and
wherein the plurality of battery cells in adjacent columns of the plurality of columns in the second direction are insulated from each other by the heat insulation sheet extending continuously between the plurality of battery cells in the adjacent columns.

16. The battery pack as claimed in claim 6, wherein the cooling plate and the heat insulation sheet between the pair of adjacent battery cells in a row of the plurality of rows comprise a plurality of cooling plates and a plurality of insulation sheets that are disconnected from each other with respect to each of the battery cells arranged adjacent to each other in the column of the plurality of columns in the second direction.

17. The battery pack as claimed in claim 16, wherein the plurality of heat insulation sheets are alternately arranged on a front surface and a rear surface of the cooling plate extending along the battery cells arranged in the second direction in the same column of the plurality of columns.

18. The battery pack as claimed in claim 17, wherein each of the plurality of battery cells comprises:
a pair of main surfaces facing each other and occupying greatest areas; and
a pair of first and second side surfaces connecting the pair of main surfaces and facing each other and occupying smallest areas,
wherein the pair of first and second side surfaces of the battery cells arranged adjacent to each other in a same column of the plurality of columns in the second direction are thermally connected to each other and face each other, and
wherein a heat flow between the pair of main surfaces of the battery cells in the same column of the plurality of columns in the second direction is disconnected by the cooling plate and the main surfaces are insulated from each other by the plurality of heat insulation sheets alternately arranged on a front surface and a rear surface of the cooling plate.

19. The battery pack as claimed in claim 6, further comprising a base frame forming a common support base for the plurality of battery cells.
